(19) United States
(12) Patent Application Publication
(10) Pub. No.: US 2009/0228558 A1
(43) Pub. Date: Sep. 10, 2009

(54) TIME MANAGEMENT FOR OUTGOING ELECTRONIC MAIL

(76) Inventor: Michael R. Brenner, Lincroft, NJ (US)

Correspondence Address: BROSEMER, KOLEFAS & ASSOCIATES, LLC (ALU), 1 BETHANY ROAD, BUILDING 4 - SUITE # 58, HAZLET, NJ, 07730, US

(21) Appl. No.: 12/042,436

(22) Filed: Mar. 5, 2008

(51) Int. Cl. G06F 15/16

(52) U.S. Cl. 709/206

(57) ABSTRACT

Apparatus and methods of delivering electronic messages, such as e-mail, which provide e-mail users with additional control over the delivery process. A sending delay timer is incorporated into e-mail products, such as e-mail client and server software. Instead of trying to catch a message after it has been sent, the present invention controls the time an outgoing message is to leave the sending e-mail client and/or server, thereby allowing the message to be retrieved for modification or deletion without relying on ineffective recall features of conventional products. A single timer may be implemented, in which case all messages would be subjected to the same delay. Alternatively, multiple timers can also be implemented, wherein the timers can be individually set to delay messages meeting certain criteria, such as the intended recipient. During the effective delayed transmission time interval, since the message is still under the control of the e-mail software client, all local operations on the message can still be performed: i.e. the message can be viewed, edited, or deleted altogether. At the expiration of the time delay interval, the last rendition of the message (if one still exists in the sender's outbound e-mailbox) would be finally sent to the target recipient's e-mail address indicated. This feature does not interfere with any other pre-existing “recall” mechanisms, which can still be exercised as desired.

### FIELD OF THE INVENTION

The present invention relates to electronic message systems and methods, and more specifically to systems and methods relating to the management of the timing of the delivery of electronic messages.

### BACKGROUND INFORMATION

e-mail (or email) is short for electronic mail, the transmission of messages typically entered from a keyboard, and possibly including electronic file attachments, over communications networks. An e-mail system may be confined to a single computer, but usually involves several computer systems (called e-mail servers and gateways) linked together over a communications network, such as the Internet, allowing the exchange of e-mail across the world. An e-mail message is typically created by composing a text message and optionally attaching files and specifying an e-mail target address or addresses to which the message is to be sent. In a common arrangement, such as illustrated in FIG. 1, messages are created at a computer employing e-mail client software 101 which forwards the messages to an e-mail server 102 for communication over a network 110 to a recipient. Messages that have been sent arrive at a destination e-mail server 121, and are stored in electronic mailboxes until the recipient downloads them using their e-mail software client 122 and opens them for reading. The messages can then be saved in an electronic file, printed, deleted, kept in an e-mailbox on the local computer where the e-mail software client 122 resides, or archived on the e-mail server 121. To check for incoming e-mail, a target recipient typically checks their received e-mail periodically, or is prompted to do so where e-mail notifications are supported by their e-mail system.

Many Internet Service Providers (ISPs) also provide e-mail services, in which case at least some of the e-mail server functionality is handled by the ISP. Regardless of the configuration of an e-mail system, however, it usually takes only a few seconds or minutes for an e-mail message to arrive at its destination.

Different e-mail systems exist and they may use different formats, but there are emerging standards that allow for interoperability. One such standard, predominant in the personal computer world, is the Messaging Application Programming Interface (MAPI), a system built into Microsoft Windows that enables different e-mail applications to work together to distribute mail. Another one is the X.400 standard (CCITT). The de-facto addressing standard is Simple Mail Transfer Protocol (SMTP, IETF RFC821) used to interface with an Internet gateway. There is also IETF RFC 822 which addresses email formats. There are some widespread software products implementing or supporting this de facto standard through interoperability with Internet e-mail gateways, including e-mail servers and e-mail software clients for sending and receiving e-mail messages. Microsoft offers e-mail servers and multiple e-mail software clients via its Microsoft Exchange Server, Microsoft Office Outlook and Outlook Express portfolios (see http://office.microsoft.com/en-ca/assistance/HA011169051033. asp). IBM offers a series of advanced electronic messaging software products under its Lotus Domino portfolio, which includes e-mail servers and software clients amongst other capabilities (see http://www-306.ibm.com/software/lotus/sw-bycategory/subcategory/SWD10.html).

Most e-mail products have only limited tools to withdraw a sent message. For example, one can express the desire to recall a previously sent message, but doing so usually only has the effect of notifying the target user that some previous message has been recalled. In the meantime, the original message has already been delivered, and may already have been read by the recipient. Even if the original message has not yet been read, in most cases the recipient will see both the original message and the recalled message notification. Theoretically, there is only a very slim chance that a recall of the original message physically occurs, namely, if the receiving e-mail server did not yet deliver the message to the target recipient. While e-mail is sent using best-effort techniques, a human must act extremely quickly to be able to beat a best-effort combination of machines and communications networks. Hence, unless the recall message is sent practically in a fraction of a second after the original message, both messages will be received by the target receiver.

A simple experiment using an industry-leading product for e-mail is revealing. The experiment entails two computers, a message-sending computer which is running (Computer #1), and a message-receiving computer which is shut down (Computer #2). Using an e-mail account with a first service provider (Account SP1), a message is sent from Computer #1 to a different e-mail account with a second service provider (Account SP2). An attempt to recall the message is immediately made. Because the two accounts are with different service providers, different outgoing and incoming mail servers are physically involved (as in the configuration shown in FIG. 1) as are other network elements (e.g., gateways) of the respective service providers. Computer #2 is then restarted and the e-mail client for Account SP2 executed thereon. Prior to this, it was impossible for any e-mail to be received by the e-mail client on Computer #2, since the e-mail client for Account SP2 could not run. Once the e-mail client is running, the incoming e-mail for Account SP2 is retrieved.

Multiple iterations of this experiment reveal that the original e-mail message and the subsequent recall message from Account SP1 are consistently received at the Account SP2 mailbox and both can be retrieved.

Such a result may appear to be indicative of a malfunction of the recall mechanism used, because the recall message should have effectively reached the receiving e-mail server before the e-mail for Account SP2 was delivered to the Account SP2 client (since it was not running at the time). It appears, however, that the recall mechanism used may attempt to catch the outgoing message at the sender, rather than trying to kill the caught-up message at the receiver. Because the recall mechanism usually cannot catch the outgoing message at the sender, the net effect is to generate and send a recall notification message without actually recalling the message.

A problem with not being able to effectively recall a message is the fact that often an e-mail user is in a situation where, by mistake, or time pressure, or reacting to some event, the user sends out a message that the user later (or sometimes almost immediately) regrets sending. And there is essentially nothing that can be done to stop it from being delivered. All that can be done is to attempt to recall it, which only results in a recall notification, and then the sender may also need to provide additional explanations about both the original message and the recall notification. The e-mail user has minimal, if any, control over e-mail that was written by them and sent to a target receiver. The consequences, however, can be dire. A more effective mechanism for recalling e-mail messages, or the like, is therefore needed.

### SUMMARY OF THE INVENTION

The present invention is directed to apparatus and methods of delivering electronic messages, such as e-mail, that overcome the above-discussed problems of conventional e-mail delivery apparatus and methods, by providing e-mail users with additional control over the delivery process. More specifically, in an exemplary embodiment of the present invention, a sending delay timer is incorporated into e-mail products. The delay timer can be implemented in an e-mail client, an e-mail server, or both.

Instead of trying to catch a message on the Internet running at wirespeed, the present invention controls the time an outgoing message would leave the sending e-mail client and/or server, thereby addressing the issue at the source of the message, rather than on the branches or leaves of a complex network tree.

A single timer may be implemented, in which case all messages would be subjected to the same delay. Alternatively, multiple timers can also be implemented, wherein the timers can be individually set to delay messages selected according to predetermined criteria, such as the intended recipient.

The one or more timers are preferably provisionable by the e-mail sender, via a feature made available in one of the e-mail software client menus (e.g. a “Tools” menu—such as the one in Microsoft Outlook). The e-mail sender would be able to set the timer(s) to a specific value (in e.g., hours, minutes, seconds) representing the time delay between the time the sender expresses her intent to send a message (such as by clicking on the “send” button), and the time the message would actually leave the sender's outbound e-mailbox. If one timer is supported, all messages would be subjected to the same delay. If multiple timers are supported, each timer could be set differently, and associated with a previously provisioned outbound folder, or a specific target recipient e-mail address, or a group of e-mail addresses, or any other grouping category supported by the e-mail client software product. The timer(s) are set to a default value, e.g., zero, which can be specified at software installation time, and can be re-provisioned anytime by the user, with the new values becoming effective immediately.

During the effective delayed transmission time interval, since the message is still under the control of the e-mail software client, all local operations on the message can still be performed: i.e. the message can be viewed, edited, or deleted altogether.

At the expiration of the time delay interval, the last rendition of the message (if one still exists in the sender's outbound e-mailbox) would be finally sent to the target recipient's e-mail address indicated. This feature does not interfere with any other pre-existing “recall” mechanisms, which can still be exercised as desired.

The aforementioned and other features and aspects of the present invention are described in greater detail below.

### BRIEF DESCRIPTION OF THE DRAWINGS

FIG. 1 is a schematic representation of elements involved in the communication of e-mail.

FIG. 2 is flow chart of an exemplary embodiment of a method of delivering e-mail in accordance with the present invention.

### DETAILED DESCRIPTION

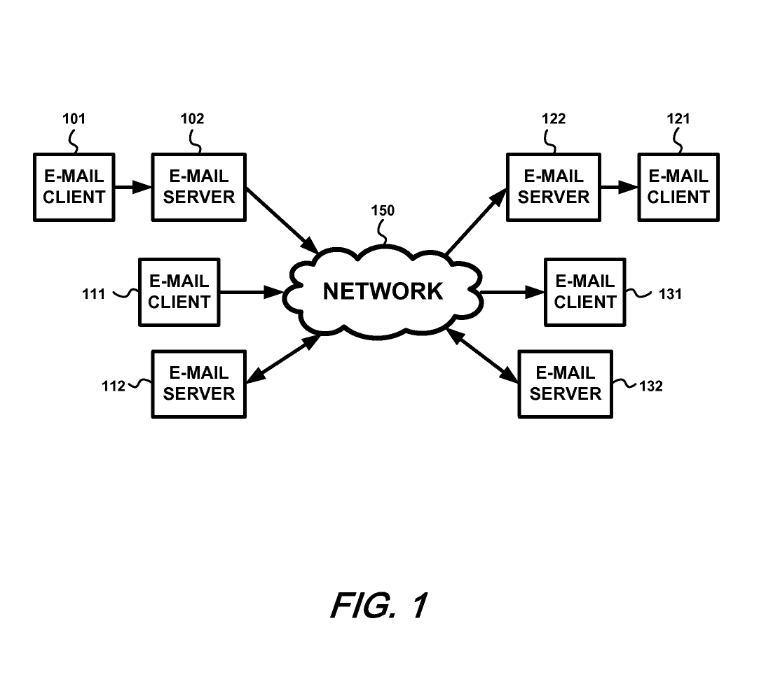

FIG. 1 shows the various elements that typically may be involved in communicating e-mail. In one variant, a sending e-mail client 101 sends e-mail to a receiving e-mail client 121 via a sending e-mail server 102, a network 150 (such as the internet), and a receiving e-mail server 122. The e-mail clients 101 and 121 reside “behind” their respective e-mail servers 102 and 122 in that e-mail messages to and from the clients go through the servers before going onto the network 150. This configuration is common, for example, in a corporate setting, where an e-mail server and multiple e-mail clients are co-located and administered by the same entity.

In another common variant, e-mail clients 111 and 131 interface directly to the network 150, as do their respective e-mail servers 112 and 132. The e-mail servers 112 and 132 may be administered by one or more service providers, for example. An e-mail message sent from the e-mail client 111 for reception by the e-mail client 131 is first sent over the network 150 to the sending e-mail server 112, which then forwards the message over the network 150 to the receiving e-mail server 132, which ultimately forwards the message over the network 150 to the e-mail client 131. This configuration is common, for example, in a residential setting, where an e-mail server is administered by an internet service provider, for example, and multiple e-mail clients are distributed over a wide area and individually administered.

Note that under the above-described configurations, various combinations of e-mail delivery scenarios are possible, such as for example, an e-mail client (e.g., 101) that resides behind a server (102) sending messages to an e-mail client (e.g., 131) that is directly coupled to the network 150, and vice versa.

In the above-described configurations, each e-mail client can be thought of as having an associated e-mail “account” that is handled by the associated e-mail server. An account defines an identity or address that is used in sending and receiving e-mail messages and sets forth various options, data (e.g., address book information), and the like, that may be involved in the sending and receiving of e-mail messages from and to the client.

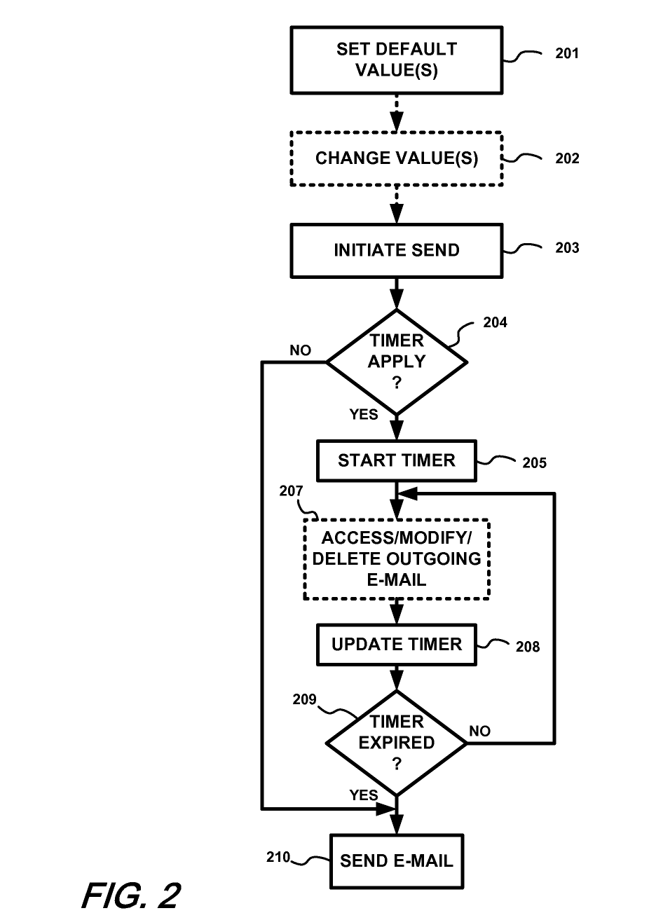

FIG. 2 is a flow chart of an exemplary embodiment of a method of sending e-mail messages in accordance with the present invention which allows a user (e.g., administrator, or an e-mail account holder) to set a timer or timers which delay the sending of all or selected outgoing e-mail messages.

An outgoing e-mail message can be delayed at the sending e-mail client, or at the sending e-mail server.

Messages can be selected for delay based on one or more characteristics of the messages, including, for example, the intended recipient, the number of intended recipients, the sender, an urgency or importance parameter specified by the user, time of day, date, message subject, message length, whether the message is sent in response to another message, or whether it is being forwarded, among other characteristics.

The delay period (e.g., 10 minutes) and/or message selection criteria can be pre-set or user programmable. The setting of timers and message selection criteria can be accomplished for example, via a “Tools” menu, or the like, from a graphical user interface (GUI) of the client.

The method of FIG. 2 may start with a set of default values for the above-described timer and message selection criteria which are set at some time 201 prior to operation. For example, the default values may be set by the manufacturer or upon installation of the client and/or server software which implements the method of the present invention, or they may be set at some later time by a system administrator or user. At some later time 202, the values may be changed by the user or a system administrator, for example. Operations may include, for example: set delay time, reset delay time to default value, view delay time, modify delay time, apply delay time to all timers, reset delay time on all timers, view all timers, set selection criteria, and so on.

At some later time 203, the user will be ready to send an e-mail message and will initiate the sending of the message such as by clicking on a “send” button of the e-mail client GUI.

At 204, a determination is made as to whether the message which the user intends to send is to be subjected to a delay. Such a determination may be made based on one or more of the selection criteria described above. If the message is not to be delayed, it is sent on for delivery at 210 in a conventional manner.

If it is determined at 204 that the message is to be delayed, operation proceeds to 205 in which the associated delay timer is started. As in conventional e-mail processing, the message may reside in an e-mail account “outbox” or the like until it is actually sent.

At 207, the delayed message can be accessed, modified, or deleted while it is in the outbox. These actions can be carried out by the e-mail account user and/or a system administrator or the like. If the message is modified, the delay timer is preferably suspended while the message is being modified.

At 208 the delay timer is updated and tested at 209 to determine whether it has expired. If not, operation loops back and waits until the timer has expired, at which point operation proceeds to 210 and the e-mail is sent on for delivery in a conventional manner.

In an exemplary embodiment, if the message is modified at 207 and the user wishes to send the modified message, the message is pulled out of the outbox and operation jumps back to 203, in which a new send procedure is initiated, subject to any applicable delays. Alternatively, the modified message can be placed back into the outbox, with its associated delay timer re-starting from its initial value or resuming from the value it had when the message was accessed for modification (i.e., the delay timer is suspended). As a further alternative, the modified message can be sent with no further delay. Such options can either be pre-selected by the user or selected during operation.

In a further exemplary embodiment, the GUI of the e-mail client can present the user with a “send now” option as well as a “send later” option. If the user clicks on “send now”, the message will be sent with no delay. If the user clicks on the “send later” button, the user can then be asked to specify a delay after which the message will be sent. Alternatively, the user may be asked to specify a time and/or date at which the message is to be sent.

In an exemplary scenario, the present invention, therefore, ensures an e-mail sender that after they wrote a message for delivery and clicked the “send” button for this message, they still have time (e.g., 10 minutes) to withdraw it, as it has either not left their e-mail client outgoing mailbox, or it has not left their outgoing e-mail box on the sending e-mail server. The user therefore need not rely on conventional recall procedures, although such procedures can still be available.

The present invention not only gives the sender the ability to re-consider and modify the text of an outgoing message, but it also has the benefit of giving the sender the assurance that they have a recourse, and hence they are under less pressure when deciding to send a message.

Furthermore, it is not expected that a sender's behavior will change; humans will continue to act as usual, and they will either click or not click the “send” button as soon as they have a message ready. This is good, because the intent is not to have the sender constantly aware that the message may be sent with delay. However, on those occasions where one feels the urge to stop an outgoing message, the fact that the feature is available and provisioned appropriately, will immediately come to mind, and the sender may then exercise the changes to the outgoing message, before it effectively leaves their computer.

Because the effective time to deliver an e-mail message remains the same and only the time the message leaves an outgoing mailbox is changed, implementation of the present invention should have no negative effects on the performance of e-mail systems. Furthermore, the feature preferably can be disabled if it is not wanted.

The present invention can also be adapted to other forms of messaging delivery, including, for example, voicemail, Multimedia Messaging, etc.

It is understood that the above-described embodiments are illustrative of only a few of the possible specific embodiments which can represent applications of the invention. Numerous and varied other arrangements can be made by those skilled in the art without departing from the spirit and scope of the invention.

What is claimed is:

1. A method of delivering electronic messages comprising:
initiating a sending of an electronic message;
determining whether the sending of the electronic message is to be delayed;
delaying the sending of the electronic message;
making the electronic message accessible for at least one of modification or deletion; and
sending the electronic message.

2. The method of claim 1 comprising:
selecting a delay period for delaying the sending of the electronic message.

3. The method of claim 1 comprising:
modifying the electronic message while the sending of the electronic message is delayed.

4. The method of claim 1 comprising:
deleting the electronic message while the sending of the electronic message is delayed.

5. The method of claim 1 wherein the step of determining whether the sending of the electronic message is to be delayed is based on at least one characteristic of the electronic message selected from the group of characteristics including an intended recipient, a number of intended recipients, a sender, an urgency parameter, a time of day, a date, a message subject, a message length, a reply status, and a forwarding status.
